(19) United States
(12) Patent Application Publication
(10) Pub. No.: US 2022/0406004 A1
(43) Pub. Date: Dec. 22, 2022

(54) IMAGE DATA GENERATION METHOD AND APPARATUS, ELECTRONIC DEVICE, AND STORAGE MEDIUM

(71) Applicant: SENSETIME INTERNATIONAL PTE. LTD., Singapore (SG)

(72) Inventors: Maoqing TIAN, Singapore (SG); Shuai YI, Singapore (SG)

(21) Appl. No.: 17/363,572

(22) Filed: Jun. 30, 2021

Related U.S. Application Data
(63) Continuation of application No. PCT/IB2021/055689, filed on Jun. 25, 2021.

(30) Foreign Application Priority Data
Jun. 21, 2021 (SG) 10202106738T

(51) Int. Cl. G06T 15/20; G06T 15/08; G06T 17/00; G06T 5/00; G06T 7/194; G06T 7/73; G06N 3/08

(52) U.S. Cl. CPC G06T 15/205; G06T 15/08; G06T 17/00; G06T 5/002; G06T 7/194; G06T 7/74; G06T 7/75; G06N 3/084; G06T 2207/10028

(57) ABSTRACT

The embodiments provide an image data generation method, which includes that: multiple virtual three-dimensional prop models respectively corresponding to multiple kinds of table game props are acquired, the table game prop being a game tool used in a table game scene; in a virtual three-dimensional table game scene, at least one virtual three-dimensional prop model including at least one kind of table game prop is randomly determined from the multiple virtual three-dimensional prop models; the at least one virtual three-dimensional prop model is overlaid to the virtual three-dimensional table game scene to form a virtual target game scene; and planar projection processing is performed on the virtual target game scene to obtain two-dimensional image data including the at least one kind of table game prop. The embodiments also disclose an image data generation apparatus, an electronic device, and a computer-readable storage medium.

### CROSS-REFERENCE TO RELATED APPLICATION

This is continuation application of international application PCT/IB2021/055689, filed on 25 Jun. 2021, which claims priority to Singaporean patent application No. 10202106738T, filed with IPOS on 21 Jun. 2021. The contents of international application PCT/IB2021/055689 and Singaporean patent application No. 10202106738T are incorporated herein by reference in their entireties.

### TECHNICAL FIELD

The disclosure relates to the technical field of image processing, and particularly to an image data generation method and apparatus, an electronic device, and a computer-readable storage medium.

### BACKGROUND

With the progress of artificial intelligence technologies and augmented reality technologies, intelligent table game applications have been developed rapidly. In an intelligent game table scene, a table game prop such as a playing card or a token in a real scene may be recognized using a recognition model, and a win-lose situation and a payout situation are further calculated according to a recognition result.

In practical applications, for training a recognition model capable of recognizing a table game prop, massive sample images including table game props are required to be collected in advance, and objects in the sample images are also required to be manually tagged. Consequently, the image data generation efficiency is reduced greatly.

### SUMMARY

Embodiments of the disclosure provide an image data generation method and apparatus, an electronic device, and a computer-readable storage medium.

The technical solutions of the embodiments of the disclosure are implemented as follows.

The embodiments of the disclosure provide an image data generation method, which may include the following operations.

Multiple virtual three-dimensional prop models respectively corresponding to multiple kinds of table game props are acquired, the table game prop being a game tool used in a table game scene. In a virtual three-dimensional table game scene, at least one virtual three-dimensional prop model including at least one kind of table game prop is randomly determined from the multiple virtual three-dimensional prop models. The at least one virtual three-dimensional prop model is overlaid to the virtual three-dimensional table game scene to form a virtual target game scene. Planar projection processing is performed on the virtual target game scene to obtain two-dimensional image data including the at least one kind of table game prop.

In some embodiments, the operation that the multiple virtual three-dimensional models respectively corresponding to the multiple kinds of table game props are acquired may include the following operations. Image collection is performed on each kind of table game prop in the multiple kinds of table game props based on multiple shooting views to obtain a view image sequence of each kind of table game prop. Three-dimensional model construction is performed on each kind of table game prop based on the view image sequence to obtain at least one virtual three-dimensional prop model corresponding to each kind of table game prop.

In some embodiments, the operation that three-dimensional model construction is performed on each kind of table game prop based on the view image sequence to obtain the at least one virtual three-dimensional prop model corresponding to each kind of table game prop may include the following operations. Three-dimensional point cloud data corresponding to at least one table game prop in each kind of table game prop is determined based on the view image sequence. Rendering processing is performed on the three-dimensional point cloud data corresponding to the at least one table game prop to obtain a virtual three-dimensional prop model corresponding to the at least one table game prop.

In some embodiments, the operation that rendering processing is performed on the three-dimensional point cloud data corresponding to the at least one table game prop may include at least one of the following operations. Surface smoothing processing is performed on the three-dimensional point cloud data, surface smoothing processing being configured to perform filtering processing on a point cloud of a surface of the three-dimensional point cloud data to obtain a surface contour of the corresponding virtual three-dimensional prop model. Texture smoothing processing is performed on the three-dimensional point cloud data, texture smoothing processing being configured to perform filtering processing on a texture of a surface image of the corresponding virtual three-dimensional prop model. Symmetry processing is performed on the three-dimensional point cloud data, symmetry processing being configured to regulate a contour shape of the three-dimensional point cloud data.

In some embodiments, the operation that the at least one virtual three-dimensional prop model is overlaid to the virtual three-dimensional game table scene to form the virtual target game scene may include the following operation. Overlaying is performed by taking the at least one virtual three-dimensional prop model as foreground information and the virtual three-dimensional table game scene as background information to obtain the virtual target game scene.

In some embodiments, the operation that the at least one virtual three-dimensional prop model is overlaid to the virtual three-dimensional table game scene to form the virtual target game scene may include the following operations. Display information of each virtual three-dimensional prop model in the at least one virtual three-dimensional prop model is determined. The at least one virtual three-dimensional prop model is overlaid to the virtual three-dimensional table game scene based on the display information of the at least one virtual three-dimensional prop model to form the virtual target game scene.

In some embodiments, the operation that the display information of each virtual three-dimensional prop model in the at least one virtual three-dimensional prop model is determined may include at least one of the following operations.

A display position of each virtual three-dimensional prop model in the at least one virtual three-dimensional prop model is determined according to a preset scene layout rule, the preset scene layout rule being a preset overlaying rule for the virtual three-dimensional prop model in the three-dimensional table game scene.

A display attitude of each virtual three-dimensional prop model in the at least one virtual three-dimensional prop model is randomly determined.

A display number of each virtual three-dimensional prop model in the at least one virtual three-dimensional prop model is randomly determined.

In some embodiments, the operation that planar projection processing is performed on the virtual target game scene to obtain the two-dimensional image data including the at least one kind of table game prop may include the following operation. Planar projection processing is performed on the virtual target game scene based on multiple projection views to obtain multiple pieces of two-dimensional image data including the at least one kind of table game prop.

In some embodiments, the following operations may further be included. A real table game scene image is acquired. Style processing is performed on the real table game scene image and the two-dimensional image data to obtain a real table game scene feature map and a two-dimensional image feature map respectively.

Style transfer is performed on the two-dimensional image feature map using the real table game scene feature map to obtain a two-dimensional image transferred feature map. Back propagation is performed based on the two-dimensional image transferred feature map to determine transferred image data after style transfer.

In some embodiments, the table game prop may include at least one of:

tokens of multiple token face types, playing cards of multiple card face types, or a dice.

The embodiments of the disclosure provide an image data generation apparatus, which may include a model acquisition unit, a model determination unit, an overlaying processing unit, and an image data generation unit.

The model acquisition unit may be configured to acquire multiple virtual three-dimensional prop models respectively corresponding to multiple kinds of table game props, the table game prop being a game tool used in a table game scene.

The model determination unit may be configured to, in a virtual three-dimensional table game scene, randomly determine at least one virtual three-dimensional prop model including at least one kind of table game prop from the multiple virtual three-dimensional prop models.

The overlaying processing unit may be configured to overlay the at least one virtual three-dimensional prop model to the virtual three-dimensional table game scene to form a virtual target game scene.

The image generation unit may be configured to perform planar projection processing on the virtual target game scene to obtain two-dimensional image data including the at least one table game prop, the two-dimensional image data being configured to train a recognition model.

In some embodiments, the model acquisition unit may specifically be configured to perform image collection on each kind of table game prop in the multiple kinds of table game props based on multiple shooting views to obtain a view image sequence of each kind of table game prop, and perform three-dimensional model construction on each kind of table game prop based on the view image sequence to obtain at least one virtual three-dimensional prop model corresponding to each kind of table game prop.

In some embodiments, the model acquisition unit may specifically be configured to determine three-dimensional point cloud data corresponding to at least one table game prop in each kind of table game prop based on the view image sequence, and perform rendering processing on the three-dimensional point cloud data corresponding to the at least one table game prop to obtain a virtual three-dimensional prop model corresponding to the at least one table game prop.

In some embodiments, the overlaying processing unit may specifically be configured to perform overlaying by taking the at least one virtual three-dimensional prop model as foreground information and the virtual three-dimensional table game scene as background information to obtain the virtual target game scene.

In some embodiments, the overlaying processing unit may specifically be configured to determine display information of each virtual three-dimensional prop model in the at least one virtual three-dimensional prop model, and overlay the at least one virtual three-dimensional prop model to the virtual three-dimensional table game scene based on the display information of the at least one virtual three-dimensional prop model to form the virtual target game scene.

In some embodiments, the image generation unit may specifically be configured to perform planar projection processing on the virtual target game scene based on multiple projection views to obtain multiple pieces of two-dimensional image data including the at least one kind of table game prop.

In some embodiments, a style transfer processing unit may further be included.

The style transfer processing unit may be configured to acquire a real table game scene image, perform style processing on the real table game scene image and the two-dimensional image data to obtain a real table game scene feature map and a two-dimensional image feature map respectively, perform style transfer on the two-dimensional image feature map using the real table game scene feature map to obtain a two-dimensional image transferred feature map, and perform back propagation based on the two-dimensional image transferred feature map to determine transferred image data after style transfer.

The embodiments of the disclosure provide an electronic device, which may include a memory and a processor.

The memory may be configured to store a computer program.

The processor may be configured to execute the computer program stored in the memory to implement the image data generation method.

The embodiments of the disclosure provide a computer-readable storage medium, which may store a computer program, configured to be executed by a processor to implement the image data generation method.

According to the image data generation method and apparatus, display device, and computer-readable storage medium provided in the embodiments of the disclosure, the multiple virtual three-dimensional prop models respectively corresponding to the multiple kinds of table game props may be acquired, and the virtual target scene is further automatically constructed according to the multiple virtual three-dimensional prop models. Then, planar projection may be performed on the virtual target game scene to automatically obtain the two-dimensional image data including the table game props. Therefore, the image data generation efficiency is improved greatly.

### BRIEF DESCRIPTION OF THE DRAWINGS

FIG. 1A is a first schematic diagram of a system architecture for an image data generation method according to an embodiment of the disclosure.

FIG. 1B is a second schematic diagram of a system architecture for an image data generation method according to an embodiment of the disclosure.

FIG. 2 is a first flowchart of an image data generation method according to an embodiment of the disclosure.

FIG. 3 is a second flowchart of an image data generation method according to an embodiment of the disclosure.

FIG. 4 is a third flowchart of an image data generation method according to an embodiment of the disclosure.

FIG. 5 is a schematic diagram of an application scene according to an embodiment of the disclosure.

FIG. 6 is a fourth flowchart of an image data generation method according to an embodiment of the disclosure.

FIG. 7 is a composition structure diagram of an image data generation apparatus according to an embodiment of the disclosure.

FIG. 8 is a composition structure diagram of an electronic device according to an embodiment of the disclosure.

### DETAILED DESCRIPTION

For making the objectives, technical solutions and advantages of the disclosure clearer, the disclosure will further be described below in detail in combination with the drawings and the embodiments. It is to be understood that specific embodiments described herein are only adopted to explain the disclosure and not intended to limit the disclosure.

Term “first/second/third” involved in the following descriptions is only for distinguishing similar objects and does not represent a specific sequence of the objects. It can be understood that “first/second/third” may be interchanged to specific sequences or orders if allowed to implement the embodiments of the disclosure described herein in sequences except the illustrated or described ones.

Unless otherwise defined, all technological and scientific terms used in the disclosure have meanings the same as those usually understood by those skilled in the art of the disclosure. The terms used in the disclosure are only adopted to describe the embodiments of the disclosure and not intended to limit the disclosure.

The embodiments of the disclosure provide an image data generation method and apparatus, an electronic device, and a storage medium. Manpower and material resources for image collection may be reduced, and the image collection efficiency may be improved. An exemplary application of the electronic device provided in the embodiments of the disclosure will be described below. The electronic device provided in the embodiments of the disclosure may be implemented as a server such as a server for training a recognition module, or may be implemented as various types of user terminals such as a notebook computer, a tablet computer, a desktop computer, and a mobile device.

A schematic diagram of a system architecture of the image data generation method provided in the embodiments of the disclosure will be described below.

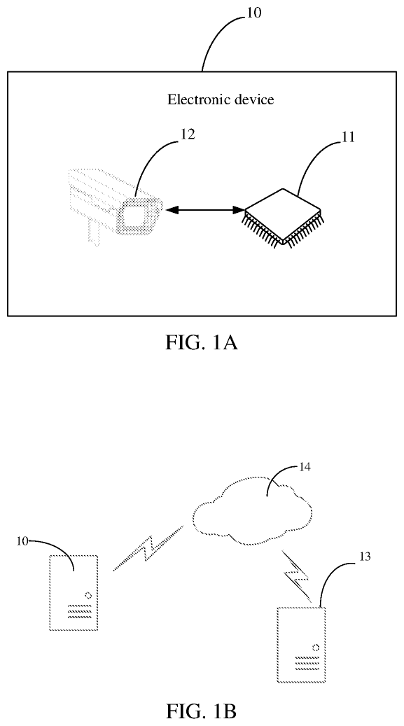

In a possible implementation mode, referring to a first schematic diagram of the system architecture for the image data generation method in FIG. 1A, the electronic device 10 may include a processing apparatus 11 and an image collection apparatus 12. In such case, the electronic device 11 may collect a view image sequence of a table game prop in different shooting views through the image collection apparatus 12, perform three-dimensional reconstruction on the view image sequence through the processing apparatus 12 to obtain a virtual three-dimensional prop model, and further perform combination and planar projection processing on multiple virtual three-dimensional prop models to generate two-dimensional image data.

In another possible implementation mode, referring to a second schematic diagram of the system architecture of the image data generation method in FIG. 1B, the electronic device 10 may receive multiple virtual three-dimensional prop models corresponding to multiple kinds of table game props from another device 13 through a network 14. As such, the electronic device 10 may perform combination and planar projection processing on the multiple virtual three-dimensional prop models to generate two-dimensional image data.

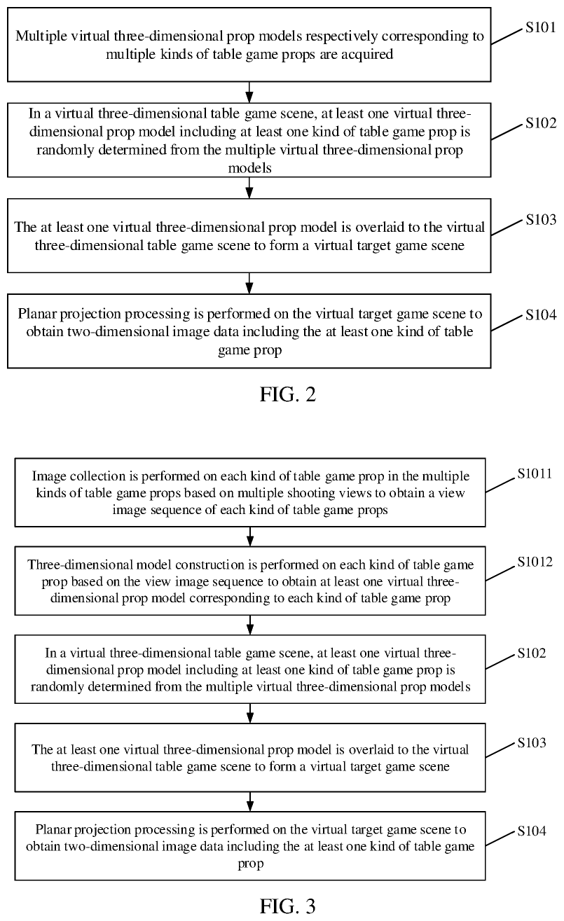

Based on the application scene, the image data generation method provided in the embodiments of the disclosure is described. Referring to FIG. 2, FIG. 2 is an optional flowchart of an image data generation method according to an embodiment of the disclosure. Descriptions will be made in combination with the operations shown in FIG. 2.

In S101, multiple virtual three-dimensional prop models respectively corresponding to multiple kinds of table game props are acquired.

The table game prop is a game tool used in a game scene. For example, the table game prop may include a token, a playing card, or a dice.

In the embodiment of the disclosure, the virtual three-dimensional prop model refers to a stereoscopic model that is reconstructed in a virtual three-dimensional space and corresponds to the table game prop. The virtual three-dimensional prop model may simulate the game table prop in a real scene in the virtual three-dimensional space.

It is to be noted that each kind of table game prop may include one virtual three-dimensional prop model, or multiple three-dimensional prop models. In an example, playing card, as a kind of table game prop, may include different card faces, and each card face in playing card may correspond to a three-dimensional prop model. Therefore, playing card may include multiple virtual three-dimensional prop models. In another example, dice, as a kind of table game prop, usually includes only one type, i.e., a cube with six faces. Therefore, dice may include one virtual three-dimensional prop model.

In the embodiment of the disclosure, an electronic device may perform three-dimensional modeling on each kind of table game prop to obtain the multiple virtual three-dimensional prop models respectively corresponding to each kind of props. In addition, the electronic device may also receive the multiple virtual three-dimensional prop models respectively corresponding to the multiple kinds of game props from another device. A source of the virtual three-dimensional prop model is not limited in the embodiment of the disclosure.

In S102, in a virtual three-dimensional table game scene, at least one virtual three-dimensional prop model including at least one kind of table game prop is randomly determined from the multiple virtual three-dimensional prop models.

For simulating a real table game scene and improving the authenticity of generated image data, the electronic device may construct the virtual three-dimensional table game scene. Exemplarily, the electronic device may construct a virtual game table for placing table game props, and a virtual game background environment.

As such, the electronic device may randomly overlay different virtual three-dimensional prop models to the virtual three-dimensional table game scene to simulate the real table game scene.

In the embodiment of the disclosure, after acquiring the multiple virtual three-dimensional prop models respectively corresponding to the multiple kinds of table game props in S101, the electronic device may randomly select a virtual three-dimensional prop model for overlaying to the virtual three-dimensional table game scene.

In the embodiment of the disclosure, the electronic device may randomly select at least one kind of table game prop from the multiple kinds of table game props, and randomly select at least one virtual three-dimensional prop model from the multiple virtual three-dimensional prop models corresponding to the selected at least one kind of table game prop. Here, the kind of the selected table game prop and the number of three-dimensional prop models corresponding to each kind of table game prop are not limited in the embodiment of the disclosure.

Exemplarily, the electronic device may select two kinds of table game props, i.e., playing card and dice. Specifically, a virtual three-dimensional prop model corresponding to card face A in the playing card, a virtual three-dimensional prop model corresponding to card face B, and a virtual three-dimensional prop model corresponding to the dice are selected.

In S103, the at least one virtual three-dimensional prop model is overlaid to the virtual three-dimensional table game scene to form a virtual target game scene.

In the embodiment of the disclosure, the electronic device may simulate the real scene. The at least one virtual three-dimensional prop model that is randomly selected is overlaid to the pre-constructed virtual three-dimensional table game scene to form the virtual target game scene to achieve an effect of simulating the real table game scene.

In some embodiments of the disclosure, the electronic device may overlay the at least one virtual three-dimensional prop model that is randomly selected to the virtual three-dimensional table game scene according to a certain rule to form the virtual target game scene. Exemplarily, the electronic device may overlay the at least one virtual three-dimensional prop model that is randomly selected to a preset region in the virtual three-dimensional table game scene, or the electronic device may overlay the virtual three-dimensional prop models to different regions according to the kinds of the table game props corresponding to the virtual three-dimensional prop models.

In some embodiments of the disclosure, the electronic device may also control the at least one virtual three-dimensional prop model to be overlaid to the virtual three-dimensional table game scene according to different positions, attitudes, and numbers to form the virtual target game scene. Exemplarily, the electronic device may overlay the at least one virtual three-dimensional prop model that is selected to the preset region of the virtual three-dimensional table game scene end to end, or the electronic device may overlay the at least one virtual three-dimensional prop model that is selected to the preset region of the virtual three-dimensional table game scene in a mutual stacking manner.

In S104, planar projection processing is performed on the virtual target game scene to obtain two-dimensional image data including the at least one kind of table game prop.

In the embodiment of the disclosure, after the virtual target game scene that simulates the real scene is obtained, the electronic device may generate an image configured to train the recognition model according to the virtual target game scene.

Since the virtual target game scene is a three-dimensional model, the electronic device may perform planar projection processing on the virtual target game scene to obtain the two-dimensional image data.

In the embodiment of the disclosure, the virtual three-dimensional prop model overlaid to the virtual target game scene is determined by the electronic device, namely the electronic device may obtain attribute information such as a type of the virtual three-dimensional prop model. Therefore, after the electronic device performs planar projection on the virtual target game scene, tag information may further be automatically added to an image content in the generated two-dimensional image data to obtain two-dimensional image data with the tag information, and the generated two-dimensional image data may be directly used for training or testing the recognition model.

In some embodiments of the disclosure, the electronic device may keep repeatedly executing S101 to S104 to acquire massive two-dimensional image data to train or test the recognition model.

It can thus be seen that the electronic device may automatically construct the virtual target game scene through the multiple virtual three-dimensional prop models, and perform planar projection on the virtual target game scene to automatically obtain the two-dimensional image data including the table game prop. As such, manual operations in image data collection and tagging processes are reduced, and the data generation efficiency is improved greatly. For some game scenes with less tag data, for example, a game scene where a new game prop is used, in the embodiment of the disclosure, a game scene image close to a real scene image may be generated efficiently by overlaying the virtual three-dimensional prop model to the virtual game scene and performing projection, to help to improve the training accuracy of a game prop recognition model suitable for the new game scene.

In some embodiments of the disclosure, the electronic device may perform planar projection processing on the virtual target game scene based on multiple projection views to obtain multiple pieces of two-dimensional image data including the at least one kind of table game prop.

It can be understood that the electronic device may perform planar projection processing on the same virtual target game scene from different projection views at different positions to obtain multiple pieces of two-dimensional image data under multiple projection views. In this manner, one virtual target game scene is constructed to generate multiple pieces of different two-dimensional image data, so that the image data generation efficiency is further improved.

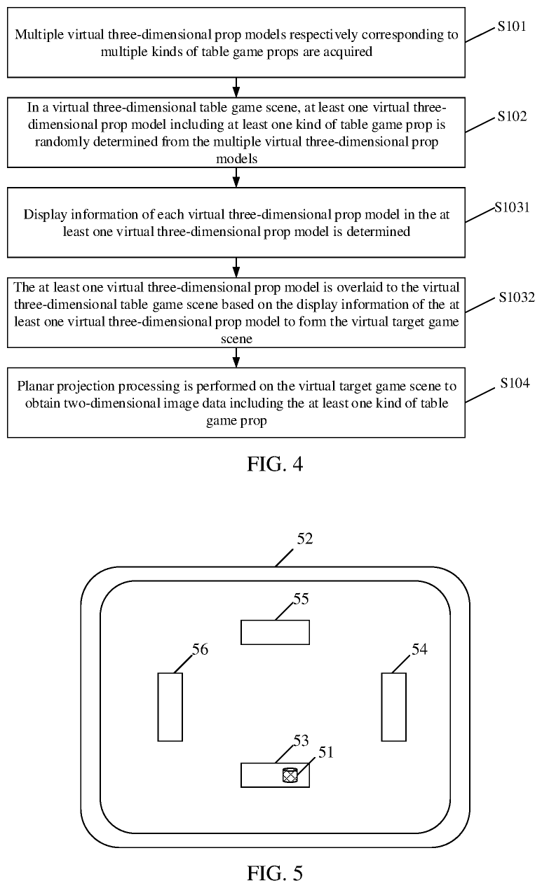

In some embodiments of the disclosure, referring to the flowchart shown in FIG. 4, the operation in S101 that the multiple virtual three-dimensional models respectively corresponding to the multiple kinds of table game props are acquired may be implemented through the following operations.

In S1011, image collection is performed on each kind of table game prop in the multiple kinds of table game props based on multiple shooting views to obtain a view image sequence of each kind of table game prop.

In S1012, three-dimensional model construction is performed on each kind of table game prop based on the view image sequence to obtain at least one virtual three-dimensional prop model corresponding to each kind of table game prop.

It can be understood that, in the embodiments of the disclosure, the electronic device may perform three-dimensional reconstruction automatically on the table game props to obtain the multiple virtual three-dimensional prop models corresponding to each kind of table game prop.

It is to be noted that the electronic device may perform three-dimensional reconstruction independently on at least one prop of different types in each kind of table game prop. Exemplarily, the electronic device may perform three-dimensional reconstruction on playing cards of multiple different card face types in playing cards respectively. The electronic device may perform three-dimensional reconstruction on tokens of multiple different token face types in tokens respectively. As such, the electronic device may obtain the multiple virtual three-dimensional prop models corresponding to each kind of table game prop to improve the diversity of the generated image data.

In the embodiments of the disclosure, the electronic device may collect the view image sequence of each kind of table game prop in each shooting view through an image collection apparatus.

Here, the view image sequence may be multiple frames of images in video data, or may be multiple frames of images that are collected independently. No limits are made thereto in the embodiments of the disclosure.

In some embodiments of the disclosure, the electronic device may collect images of a table game prop placed in a solid background environment from each shooting view to obtain a view image sequence to extract a feature of the table game prop for three-dimensional reconstruction more accurately and reduce the influence of background information in construction of the virtual three-dimensional model corresponding to the table game prop.

In the embodiments of the disclosure, the electronic device, after collecting the view image sequence of each table game prop, may perform three-dimensional model reconstruction on the table game prop using a Structure From Motion (SfM) algorithm. Specifically, the electronic device may extract a motion parameter of a pixel in the view image sequence, and construct the virtual three-dimensional prop model corresponding to the table game prop based on the motion parameter of the pixel.

It can thus be seen that the electronic device is only required to construct the virtual three-dimensional prop models corresponding to each kind of table game prop and combine the virtual three-dimensional prop models corresponding to different kinds of table game props to obtain the virtual target game scene, to generate rich and diversified image data. Therefore, the image data generation efficiency is improved.

In some embodiments of the disclosure, the operation in S1012 that three-dimensional model construction is performed on each kind of table game prop based on the view image sequence to obtain the at least one virtual three-dimensional prop model corresponding to each kind of table game prop may be implemented through the following operations.

Three-dimensional point cloud data corresponding to at least one table game prop in each kind of table game prop is determined based on the view image sequence.

Rendering processing is performed on the three-dimensional point cloud data corresponding to the at least one table game prop to obtain a virtual three-dimensional prop model corresponding to the at least one table game prop, thereby obtaining the at least one virtual three-dimensional prop model corresponding to each kind of table game prop.

In the embodiments of the disclosure, SfM processing may be performed on the view image sequence to preliminarily obtain the three-dimensional point cloud data corresponding to the shot table game prop in the view image sequence.

In the embodiments of the disclosure, rendering optimization processing is further required to be performed on the preliminarily obtained three-dimensional point cloud data corresponding to the table game prop to improve the authenticity of the virtual three-dimensional prop model.

In some embodiments of the disclosure, the operation that rendering processing is performed on the three-dimensional point cloud data corresponding to the at least one table game prop may include at least one of the following operations.

Surface smoothing processing is performed on the three-dimensional point cloud data, surface smoothing processing being configured to perform filtering processing on a point cloud of a surface of the three-dimensional point cloud data to obtain a surface contour of the corresponding virtual three-dimensional prop model.

Texture smoothing processing is performed on the three-dimensional point cloud data, texture smoothing processing being configured to perform filtering processing on a texture of a surface image of the corresponding virtual three-dimensional prop model.

Symmetry processing is performed on the three-dimensional point cloud data, symmetry processing being configured to regulate a contour shape of the three-dimensional point cloud data.

It can be understood that the electronic device may perform smoothing processing on the surface of the preliminarily constructed three-dimensional point cloud data such that the three-dimensional point cloud may form a complete surface contour. Furthermore, the electronic device may perform texture smoothing processing on the three-dimensional point cloud data after surface smoothing processing is completed. That is, the electronic device may perform screening, fusion, and smoothing processing on the texture on the surface contour formed by the three-dimensional point cloud data to filter pixels of which pixel values are greatly different from pixel values of other pixels around. Finally, the electronic device may modify the contour shape formed by the three-dimensional point cloud data to make more symmetric and uniform a shape of the generated virtual three-dimensional prop model.

In some embodiments of the disclosure, referring to the flowchart shown in FIG. 4, the operation in S103 that the at least one virtual three-dimensional prop model is overlaid to the virtual three-dimensional table game scene to form the virtual target game scene may be implemented through the following operations.

In S1031, display information of each virtual three-dimensional prop model in the at least one virtual three-dimensional prop model is determined.

In S1032, the at least one virtual three-dimensional prop model is overlaid to the virtual three-dimensional table game scene based on the display information of the at least one virtual three-dimensional prop model to form the virtual target game scene.

In the embodiments of the disclosure, the electronic device may randomly select one or more virtual three-dimensional prop models from the multiple virtual three-dimensional prop models corresponding to the multiple kinds of table game props, and overlay the selected virtual three-dimensional prop model to the virtual three-dimensional table game scene according to a certain rule to obtain the virtual target game scene.

Here, the virtual three-dimensional table game scene may include three-dimensional information of the game table, and may specifically include three-dimensional information of a region for placing the table game prop on a tabletop of the game table. Alternatively, the virtual three-dimensional table game scene may include position information of the tabletop and background information of the tabletop. The background information of the tabletop is, for example, a type of table cloth or game region division information of the table cloth.

In some embodiments of the disclosure, the electronic device, after selecting the at least one virtual three-dimensional prop model, may determine the display information of each virtual three-dimensional prop model, and overlay the corresponding virtual three-dimensional prop model to the virtual three-dimensional table game scene according to the display information of each virtual three-dimensional prop model.

Here, the display information may include at least one of a display position, display attitude, or display number of the virtual three-dimensional prop model.

In some other embodiments, the electronic device may convert the virtual three-dimensional prop model and the virtual three-dimensional table game scene into the same coordinate system, and then perform overlaying by taking the virtual three-dimensional prop model as foreground information and the virtual three-dimensional table game scene as background information to obtain the virtual target game scene including virtual three-dimensional props placed on a tabletop of a virtual game table.

It can be understood that the electronic device, before overlaying the multiple virtual three-dimensional prop models, may determine the display position, display attitude, and display number of each virtual three-dimensional prop model. As such, the electronic device may combine the multiple virtual three-dimensional prop models based on the display position, display attitude, and display number of each virtual three-dimensional prop model, and overlay multiple virtual three-dimensional prop models obtained by combination to the virtual three-dimensional table game scene.

The display position refers to an overlaying position of the virtual three-dimensional prop model in the virtual three-dimensional table game scene. For example, the display position may be coordinate information of the virtual three-dimensional prop model in the virtual three-dimensional table game scene.

The display attitude refers to an attitude of the virtual three-dimensional prop model placed in the virtual three-dimensional table game scene. For example, the virtual three-dimensional prop model corresponding to the playing card may be overlaid to the virtual three-dimensional table game scene in a face-up manner, or overlaid to the virtual three-dimensional table game scene in a face-down manner.

The display number refers to the number of the virtual three-dimensional prop model in the virtual three-dimensional table game scene. That is, multiple identical virtual three-dimensional prop models may be overlaid to the virtual three-dimensional table game scene. It is to be noted that, under the condition that the number of a virtual three-dimensional prop model is multiple, the electronic device may set a different display position and a different display attitude for each virtual three-dimensional prop model.

In some embodiments of the disclosure, the operation in S1031 that the display information of each virtual three-dimensional prop model in the at least one virtual three-dimensional prop model is determined includes at least one of the following operations.

A display position of each virtual three-dimensional prop model in the at least one virtual three-dimensional prop model is determined according to a preset scene layout rule, the preset scene layout rule being a preset overlaying rule for the virtual three-dimensional prop model in the three-dimensional table game scene.

A display attitude of each virtual three-dimensional prop model in the at least one virtual three-dimensional prop model is randomly determined.

A display number of each virtual three-dimensional prop model in the at least one virtual three-dimensional prop model is randomly determined.

In practical applications, all the table game props are required to be placed in the preset region of the table game scene. For example, the table game props are required to be placed in a central region of the game table. In addition, different kinds of table game props are placed at different positions in the preset region. For example, playing cards may be placed at a middle position on each side edge of the game table, while game chips are required to be placed in a corner formed by two sides of the game table.

Based on this, the electronic device may simulate a layout rule in the real scene to overlay the at least one virtual three-dimensional prop model to the virtual three-dimensional table game scene.

Specifically, the electronic device may acquire the preset scene layout rule corresponding to the virtual three-dimensional table game scene, and then determine the display position of each virtual three-dimensional prop model according to the preset scene layout rule. Here, the preset scene layout rule may be a region where each virtual three-dimensional prop model is not allowed to be placed. For example, the three-dimensional prop model of the playing card is not allowed to be placed in a range of 20 millimeters from an edge of the virtual game table. The preset scene layout rule may also be a region where each virtual three-dimensional prop model is allowed to be placed. For example, the three-dimensional prop model of the token is placed in the central region of the virtual game table. The preset scene layout rule is not limited in the embodiments of the disclosure.

In some embodiments of the disclosure, the operation that the display position of each virtual three-dimensional prop model in the at least one virtual three-dimensional prop model is determined according to the preset scene layout rule may be implemented through the following operations.

A target overlaying region corresponding to the at least one virtual three-dimensional prop model is determined according to the preset scene layout rule respectively. The virtual three-dimensional prop models corresponding to each kind of table game props corresponds to one target overlaying region respectively.

The display position of each virtual three-dimensional prop model is randomly determined in the target overlaying region.

It is to be noted that, like placement of different kinds of table game props in different regions in the table game scene in the real scene, in the embodiments of the disclosure, the virtual three-dimensional prop models corresponding to each kind of table game props corresponds to one target overlaying region respectively.

It can be understood that the electronic device may determine the type of the table game prop corresponding to each virtual three-dimensional prop model at first, and determine the target overlaying region corresponding to each virtual three-dimensional prop model based on the type of the table game prop. Here, an area of the target overlaying region is larger than an area of the virtual three-dimensional prop model. Furthermore, the electronic device may randomly determine a specific position in the target overlaying region as the display position of the virtual three-dimensional prop model.

That is, the electronic device may determine a regional range that the virtual three-dimensional prop model may be overlaid to at first, and then randomly determine a specific display position for the virtual three-dimensional prop model in this regional range.

Exemplarily, referring to a schematic diagram of an application scene shown in FIG. 5, the electronic device may overlay a virtual three-dimensional prop model 51 corresponding to a game chip to a virtual game table 52. There are totally four regions (region 53 to region 56) for placing the game chip 51 on a tabletop of the virtual game table 52. Based on this, the electronic device, when determining a display position of the virtual three-dimensional prop model 51 corresponding to the game chip, may determine a target overlaying region for the virtual three-dimensional prop model 51 corresponding to the game chip at first. The target overlaying region includes region 53 to region 56. Furthermore, the electronic device may randomly select region 53 from the target overlaying region as the display position of the virtual three-dimensional prop model 51.

In the embodiments of the disclosure, the electronic device may randomly determine the display attitude and display number of the virtual three-dimensional prop model.

In summary, the electronic device, after determining the at least one virtual three-dimensional prop model, may overlaid to the at least one virtual three-dimensional prop model to the virtual three-dimensional table game scene according to a random display position, display attitude and display number. As such, the diversity and richness of the target game scene are improved, and meanwhile, the diversity and richness of the generated image data are improved.

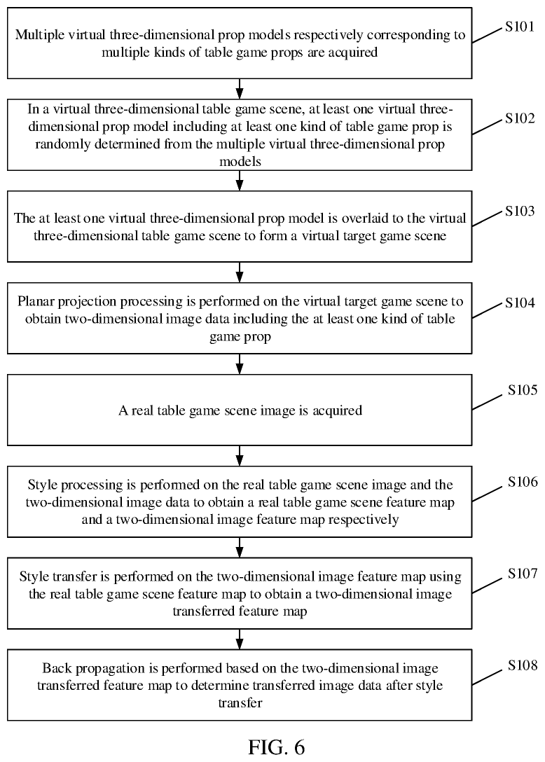

In some embodiments of the disclosure, referring to FIG. 6, the image data generation method provided in the embodiments of the disclosure may further include the following operations.

In S105, a real table game scene image is acquired.

In practical applications, different table game props are used in different table game scenes. For example, fonts on playing cards in some table game scenes are flourish, and fonts on playing cards in some table game scenes are boldface.

Based on this, in the embodiments of the disclosure, the electronic device may perform style transfer on the two-dimensional image data generated in S104 based on a neural network technology to make a style of the generated two-dimensional image data closer to the real table game scene image and improve the image data generation quality.

Specifically, the electronic device may acquire the real table game scene image to perform style transfer on the two-dimensional image data generated in S104 with reference to a style in the real table game scene image. Here, the electronic device may acquire a single real table game scene image, or multiple real table game scene images. No limits are made thereto in the embodiments of the disclosure.

In S106, style processing is performed on the real table game scene image and the two-dimensional image data to obtain a real table game scene feature map and a two-dimensional image feature map respectively.

In the embodiments of the disclosure, the electronic device may extract a style related image feature from the real table game scene image to obtain the real table game scene feature map. Meanwhile, the electronic device may also extract a style related feature image from the two-dimensional image data to obtain the two-dimensional image feature map. As such, the obtained real table game scene feature map and two-dimensional image feature map may include rich style information.

The style related image feature may be a font related image feature, or a shape feature of the playing card, etc. No limits are made thereto in the embodiments of the disclosure.

In S107, style transfer is performed on the two-dimensional image feature map using the real table game scene feature map to obtain a two-dimensional image transferred feature map.

In S108, back propagation is performed based on the two-dimensional image transferred feature map to determine transferred image data after style transfer.

The transferred image data is configured to train or test the recognition model.

In the embodiments of the disclosure, the electronic device may pre-train a style transfer model to perform style transfer on the two-dimensional image feature map. The style transfer model may be constructed based on the neural network technology.

Specifically, the electronic device may perform style transfer processing on the two-dimensional image feature map using the style transfer model to obtain the two-dimensional image transferred feature map. Here, the two-dimensional image transferred feature map may be obtained only by performing style transfer on a local region of the two-dimensional image data. Therefore, after the two-dimensional image transferred feature map, back propagation processing may be performed based on the two-dimensional image transferred feature map to extend local style transfer to the whole two-dimensional image to obtain the transferred image data after transfer.

As such, an image style of the transferred image data obtained by style transfer processing may be closer to the real table game scene, the generated image data can be used to train a variety of recognition models of different real table game scenes. a Thus the problem of difficulty of collecting a large number of images for different real table game scenes is solved. Therefore, the image data generation efficiency is improved.

The image data generation method provided in the embodiments of the disclosure will be described below in detail in combination with a specific application scene.

The image data generation method provided in the embodiments of the disclosure may include the following operations.

At block a, a virtual three-dimensional prop model corresponding to a table game prop is constructed.

In the embodiments of the disclosure, a purpose of block a is to automatically reconstruct a virtual three-dimensional prop model corresponding to each table game prop in a table game scene through an algorithm. The table game prop may be a game chip, a dice, a playing card, etc.

Here, an electronic device may collect video data of the table game prop in different shooting views, and construct the virtual three-dimensional prop model corresponding to the table game prop based on the video data of the table game prop in different views.

Specifically, block a includes the following operations.

At block a1, video data of the table game prop in different shooting views is acquired.

Here, the table game prop may be placed on a background interference free solid tabletop to collect video data including a small object in each shooting view.

At block a2, three-dimensional point cloud data corresponding to the table game prop is constructed based on the video data in the different shooting views.

Here, the electronic device may perform SfM-algorithm-based processing on a video collected in block a1 to preliminarily reconstruct the three-dimensional point cloud data corresponding to the table game prop.

At block a3, rendering processing is performed on the three-dimensional point cloud data to obtain the virtual three-dimensional prop model.

Here, the electronic device may perform rendering optimization on the three-dimensional point cloud data corresponding to the table game prop, including surface smoothing processing, texture smoothing processing, symmetry processing, etc. Surface smoothing processing refers to performing smoothing processing on a surface of the three-dimensional point cloud data to obtain a smoother surface contour of the virtual three-dimensional prop model. Texture smoothing processing refers to performing smoothing processing on a texture map of the surface contour of the three-dimensional point cloud data, and screening, fusion, and smoothing processing are performed on the texture map obtained by multiple frames of images in the video. Symmetry processing refers to modifying a contour shape of the three-dimensional point cloud data to make more symmetric and uniform a shape of the generated virtual three-dimensional prop model.

At block b, two-dimensional image data is generated based on the virtual three-dimensional prop model.

Specifically, the electronic device may randomly combine virtual three-dimensional prop models corresponding to multiple table game props in a virtual three-dimensional table game scene to obtain a virtual target game scene.

Here, the electronic device may set a random display position, display attitude and display number for the virtual three-dimensional prop model corresponding to each table game prop, and overlay the multiple table game props to the virtual three-dimensional table game scene according to the set display positions, display attitudes and display numbers to obtain the virtual target game scene.

Furthermore, the electronic device performs planar projection processing on the virtual target game scene to generate the two-dimensional image data.

At block c, style transfer is performed on the two-dimensional image data.

Specifically, the electronic device may collect a real table game scene image, and perform style transfer on the two-dimensional image data generated in block b with reference to the real table game scene image to make a style of the two-dimensional image data closer to an image style in the real table game scene.

It can thus be seen that, according to the image data generation method provided in the embodiments of the disclosure, manual operations in image data collection and tagging processes may be reduced, and the image data generation efficiency is improved greatly. In addition, the electronic device may perform three-dimensional modeling on the table game prop based on an SfM algorithm, and perform style transfer on the generated two-dimensional image data, so that the image data generation efficiency and quality are improved.

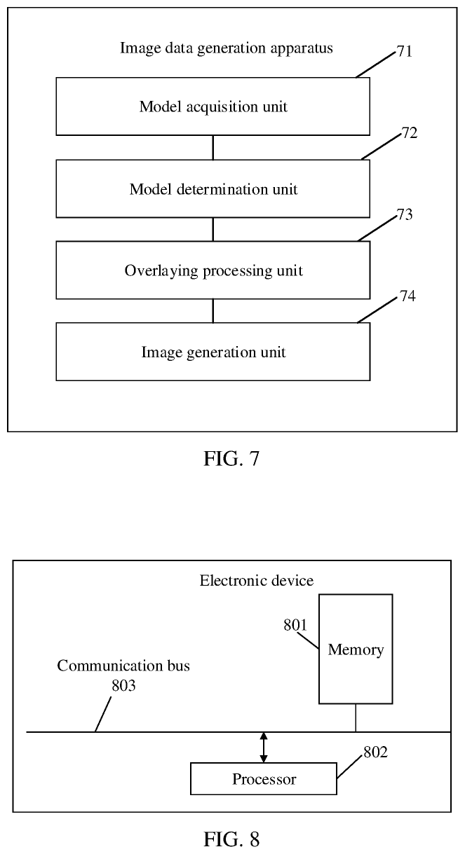

FIG. 7 is a first structure composition diagram of an image data generation apparatus according to an embodiment of the disclosure. As shown in FIG. 6, the image data generation apparatus includes a model acquisition unit 71, a model determination unit 72, an overlaying processing unit 73, and an image generation unit 74.

The model acquisition unit 71 is configured to acquire multiple virtual three-dimensional prop models respectively corresponding to multiple kinds of table game props, the table game prop being a game tool used in a table game scene.

The model determination unit 72 is configured to, in a virtual three-dimensional table game scene, randomly determine at least one virtual three-dimensional prop model including at least one kind of table game prop from the multiple virtual three-dimensional prop models.

The overlaying processing unit 73 is configured to overlay the at least one virtual three-dimensional prop model to the virtual three-dimensional table game scene to form a virtual target game scene.

The image generation unit 74 is configured to perform planar projection processing on the virtual target game scene to obtain two-dimensional image data including the at least one kind of table game prop.

In some embodiments, the model acquisition unit 71 is specifically configured to perform image collection on each kind of table game prop in the multiple kinds of table game props to obtain a view image sequence of each kind of table game prop, and perform three-dimensional model construction on each kind of table game prop based on the view image sequence to obtain at least one virtual three-dimensional prop model corresponding to each kind of table game prop.

In some embodiments, the model acquisition unit 71 is further configured to determine three-dimensional point cloud data corresponding to at least one table game prop in each kind of table game prop based on the view image sequence, and perform rendering processing on the three-dimensional point cloud data corresponding to the at least one table game prop to obtain a virtual three-dimensional prop model corresponding to the at least one table game prop.

In some embodiments, the operation that rendering processing is performed on the three-dimensional point cloud data corresponding to the at least one table game prop includes at least one of the following operations.

Surface smoothing processing is performed on the three-dimensional point cloud data, surface smoothing processing being configured to perform filtering processing on a point cloud of a surface of the three-dimensional point cloud data to obtain a surface contour of the corresponding virtual three-dimensional prop model.

Texture smoothing processing is performed on the three-dimensional point cloud data, texture smoothing processing being configured to perform filtering processing on a texture of a surface image of the corresponding virtual three-dimensional prop model.

Symmetry processing is performed on the three-dimensional point cloud data, symmetry processing being configured to regulate a contour shape of the three-dimensional point cloud data.

In some embodiments, the overlaying processing unit 73 is specifically configured to perform overlaying by taking the at least one virtual three-dimensional prop model as foreground information and the virtual three-dimensional table game scene as background information to obtain the virtual target game scene.

In some embodiments, the overlaying processing unit 73 is specifically configured to determine display information of each virtual three-dimensional prop model in the at least one virtual three-dimensional prop model, and overlay the at least one virtual three-dimensional prop model to the virtual three-dimensional table game scene based on the display information of the at least one virtual three-dimensional prop model to form the virtual target game scene.

In some embodiments, the overlaying processing unit 73 is further configured to determine a display position of each virtual three-dimensional prop model in the at least one virtual three-dimensional prop model according to a preset scene layout rule, the preset scene layout rule being a preset overlaying rule for the virtual three-dimensional prop model in the three-dimensional table game scene, randomly determine a display attitude of each virtual three-dimensional prop model in the at least one virtual three-dimensional prop model, and randomly determine a display number of each virtual three-dimensional prop model in the at least one virtual three-dimensional prop model.

In some embodiments, the overlaying processing unit 73 is further configured to determine a target overlaying region corresponding to the at least one virtual three-dimensional prop model according to the preset scene layout rule respectively, the virtual three-dimensional prop models corresponding to each kind of table game props corresponding to one target overlaying region respectively, and randomly determine the display position of each virtual three-dimensional prop model in the target overlaying region.

In some embodiments, the image generation unit 74 is specifically configured to perform planar projection processing on the virtual target game scene based on multiple projection views to obtain multiple pieces of two-dimensional image data including the at least one kind of table game prop.

In some embodiments, the image data generation apparatus may further include a style transfer processing unit, specifically configured to acquire a real table game scene image, perform style processing on the real table game scene image and the two-dimensional image data to obtain a real table game scene feature map and a two-dimensional image feature map respectively, perform style transfer on the two-dimensional image feature map using the real table game scene feature map to obtain a two-dimensional image transferred feature map, and perform back propagation based on the two-dimensional image transferred feature map to determine transferred image data after style transfer.

In some embodiments, the table game prop includes at least one of tokens of multiple token face types, playing cards of multiple card face types, or a dice.

Correspondingly, the embodiments of the disclosure provide an electronic device. FIG. 8 is a structure diagram of an electronic device according to an embodiment of the disclosure. As shown in FIG. 8, the electronic device includes a memory 801, a processor 802, and a computer program stored in the memory 801 and capable of running in the processor 802. The processor 802 is configured to run the computer program to implement the image data generation method in the abovementioned embodiments.

It can be understood that the electronic device further includes a bus system 803. Each component in the electronic device is coupled together through the bus system 803. It can be understood that the bus system 803 is configured to implement connection communication between these components. The bus system 803 includes a data bus, and further includes a power bus, a control bus, and a state signal bus.

The memory 801 is configured to store the computer program and application executed by the processor 802, may also cache data of the processor 802, and may be implemented by a flash and a Random Access Memory (RAM).

The processor 802 executes the program to implement the steps of any abovementioned image data generation method.

The embodiments of the disclosure provide a computer storage medium, which stores one or more programs. The one or more programs may be executed by one or more processors to implement the steps of the image data generation method in any abovementioned embodiment.

It is to be pointed out here that the above descriptions about the storage medium and device embodiments are similar to the descriptions about the method embodiment and beneficial effects similar to those of the method embodiment are achieved. Technical details undisclosed in the storage medium and device embodiments of the disclosure are understood with reference to the descriptions about the method embodiment of the disclosure.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a controller, a microcontroller, or a microprocessor. It can be understood that other electronic devices may also be configured to realize functions of the processor, and no specific limits are made in the embodiments of the disclosure.

The computer storage medium/memory may be a memory such as a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any terminal including one or any combination of the abovementioned memories, such as a mobile phone, a computer, a tablet device, and a personal digital assistant.

It is to be understood that “one embodiment” or “an embodiment” or “the embodiment of the disclosure” or “the abovementioned embodiment” or “some embodiments” mentioned in the whole specification means that target features, structures or characteristics related to the embodiment are included in at least one embodiment of the disclosure. Therefore, “in one embodiment” or “in an embodiment” or “the embodiment of the disclosure” or “the abovementioned embodiment” or “some embodiments” appearing everywhere in the whole specification does not always refer to the same embodiment. In addition, these target features, structures or characteristics may be combined in one or more embodiments freely as appropriate. It is to be understood that, in each embodiment of the disclosure, a magnitude of a sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

If not specified, when the detection device executes any step in the embodiments of the disclosure, the processor of the detection device executes the step. Unless otherwise specified, the sequence of execution of the following steps by the detection device is not limited in the embodiments of the disclosure. In addition, the same method or different methods may be used to process data in different embodiments. It is also to be noted that any step in the embodiments of the disclosure may be executed independently by the detection device, namely the detection device may execute any step in the abovementioned embodiments independent of execution of the other steps.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each function unit in each embodiment of the disclosure may be integrated into a processing unit, each unit may also serve as an independent unit and two or more than two units may also be integrated into a unit. The integrated unit may be implemented in a hardware form and may also be implemented in form of hardware and software function unit.

The methods disclosed in some method embodiments provided in the disclosure may be freely combined without conflicts to obtain new method embodiments.

The characteristics disclosed in some product embodiments provided in the disclosure may be freely combined without conflicts to obtain new product embodiments.

The characteristics disclosed in some method or device embodiments provided in the disclosure may be freely combined without conflicts to obtain new method embodiments or device embodiments.

Those of ordinary skill in the art should know that all or part of the steps of the method embodiment may be implemented by related hardware instructed through a program, the program may be stored in a computer-readable storage medium, and the program is executed to execute the steps of the method embodiment. The storage medium includes: various media capable of storing program codes such as a mobile storage device, a ROM, a magnetic disk, or an optical disc.

Alternatively, when implemented in form of a software function module and sold or used as an independent product, the integrated unit of the disclosure may also be stored in a computer-readable storage medium. Based on such an understanding, the technical solutions of the embodiments of the disclosure substantially or parts making contributions to the related art may be embodied in form of a software product. The computer software product is stored in a storage medium, including a plurality of instructions configured to cause a computer device (which may be a personal computer, a detection device, a network device, etc.) to execute all or part of the method in each embodiment of the disclosure. The storage medium includes: various media capable of storing program codes such as a mobile hard disk, a ROM, a magnetic disk, or an optical disc.

In the embodiments of the disclosure, the descriptions about the same steps and the same contents in different embodiments may refer to those in the other embodiments. In the embodiments of the disclosure, term “and” does not influence the sequence of the steps.

The above is only the implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. An image data generation method, comprising:
acquiring a plurality of virtual three-dimensional prop models respectively corresponding to a plurality of kinds of table game props, the table game prop being a game tool used in a table game scene;
in a virtual three-dimensional table game scene, randomly determining at least one virtual three-dimensional prop model comprising at least one kind of table game prop from the plurality of virtual three-dimensional prop models;
overlaying the at least one virtual three-dimensional prop model to the virtual three-dimensional table game scene to form a virtual target game scene; and
performing planar projection processing on the virtual target game scene to obtain two-dimensional image data comprising the at least one kind of table game prop.

2. The method of claim 1, wherein acquiring the plurality of virtual three-dimensional prop models respectively corresponding to the plurality of kinds of table game props comprises:
performing image collection on each kind of table game prop in the plurality of kinds of table game props based on a plurality of shooting views to obtain a view image sequence of the each kind of table game prop; and
performing three-dimensional model construction on the each kind of table game prop based on the view image sequence to obtain at least one virtual three-dimensional prop model corresponding to each kind of table game prop.

3. The method of claim 2, wherein performing the three-dimensional model construction on the each kind of table game prop based on the view image sequence to obtain the at least one virtual three-dimensional prop model corresponding to the each kind of table game prop comprises:
determining three-dimensional point cloud data corresponding to at least one table game prop in the each kind of table game prop based on the view image sequence; and
performing rendering processing on the three-dimensional point cloud data corresponding to the at least one table game prop to obtain a virtual three-dimensional prop model corresponding to the at least one table game prop.

4. The method of claim 3, wherein performing the rendering processing on the three-dimensional point cloud data corresponding to the at least one table game prop comprises at least one of:
performing surface smoothing processing on the three-dimensional point cloud data, the surface smoothing processing being configured to perform filtering processing on a point cloud of a surface of the three-dimensional point cloud data to obtain a surface contour of the corresponding virtual three-dimensional prop model;
performing texture smoothing processing on the three-dimensional point cloud data, the texture smoothing processing being configured to perform filtering processing on a texture of a surface image of the corresponding virtual three-dimensional prop model; or
performing symmetry processing on the three-dimensional point cloud data, the symmetry processing being configured to regulate a contour shape of the three-dimensional point cloud data.

5. The method of claim 1, wherein overlaying the at least one virtual three-dimensional prop model to the virtual three-dimensional table game scene to form the virtual target game scene comprises:
performing overlaying by taking the at least one virtual three-dimensional prop model as foreground information and the virtual three-dimensional table game scene as background information to obtain the virtual target game scene.

6. The method of claim 1, wherein overlaying the at least one virtual three-dimensional prop model to the virtual three-dimensional table game scene to form the virtual target game scene comprises:
determining display information of each virtual three-dimensional prop model in the at least one virtual three-dimensional prop model; and
overlaying the at least one virtual three-dimensional prop model to the virtual three-dimensional table game scene based on the display information of the at least one virtual three-dimensional prop model to form the virtual target game scene.

7. The method of claim 6, wherein determining the display information of each virtual three-dimensional prop model in the at least one virtual three-dimensional prop model comprises at least one of the following operations:
determining a display position of each virtual three-dimensional prop model in the at least one virtual three-dimensional prop model according to a preset scene layout rule, the preset scene layout rule being a preset overlaying rule for the virtual three-dimensional prop model in the virtual three-dimensional table game scene;
randomly determining a display attitude of each virtual three-dimensional prop model in the at least one virtual three-dimensional prop model; and
randomly determining a display number of each virtual three-dimensional prop model in the at least one virtual three-dimensional prop model.

8. The method of claim 7, wherein determining the display position of each virtual three-dimensional prop model in the at least one virtual three-dimensional prop model according to the preset scene layout rule comprises:
determining a target overlaying region corresponding to the at least one virtual three-dimensional prop model according to the preset scene layout rule respectively, wherein the virtual three-dimensional prop models corresponding to each kind of table game props corresponds to one target overlaying region respectively; and
randomly determining the display position of each virtual three-dimensional prop model in the target overlaying region.

9. The method of claim 1, wherein performing the planar projection processing on the virtual target game scene to obtain the two-dimensional image data comprising the at least one kind of table game prop comprises:
performing the planar projection processing on the virtual target game scene based on a plurality of projection views to obtain a plurality of pieces of two-dimensional image data comprising the at least one kind of table game prop.

10. The method of claim 1, further comprising:
acquiring a real table game scene image;
performing style processing on the real table game scene image and the two-dimensional image data to obtain a real table game scene feature map and a two-dimensional image feature map respectively;
performing style transfer on the two-dimensional image feature map using the real table game scene feature map to obtain a two-dimensional image transferred feature map; and
performing back propagation based on the two-dimensional image transferred feature map to determine transferred image data after style transfer.

11. The method of claim 1, wherein the table game prop comprises at least one of:
tokens of a plurality of token face types, playing cards of a plurality of card face types, or a dice.

12. An electronic device, comprising a processor and a memory configured to store a computer program capable of running in the processor,
wherein the processor is configured to run the computer program to:
acquire a plurality of virtual three-dimensional prop models respectively corresponding to a plurality of kinds of table game props, the table game prop being a game tool used in a table game scene;
in a virtual three-dimensional table game scene, randomly determine at least one virtual three-dimensional prop model comprising at least one kind of table game prop from the plurality of virtual three-dimensional prop models;
overlay the at least one virtual three-dimensional prop model to the virtual three-dimensional table game scene to form a virtual target game scene; and
perform planar projection processing on the virtual target game scene to obtain two-dimensional image data comprising the at least one kind of table game prop.

13. The electronic device of claim 12, wherein the processor is specifically configured to:
perform image collection on each kind of table game prop in the plurality of kinds of table game props based on a plurality of shooting views to obtain a view image sequence of the each kind of table game prop; and
perform three-dimensional model construction on the each kind of table game prop based on the view image sequence to obtain at least one virtual three-dimensional prop model corresponding to each kind of table game prop.

14. The electronic device of claim 13, wherein the processor is specifically configured to:
determine three-dimensional point cloud data corresponding to at least one table game prop in the each kind of table game prop based on the view image sequence; and
perform rendering processing on the three-dimensional point cloud data corresponding to the at least one table game prop to obtain a virtual three-dimensional prop model corresponding to the at least one table game prop.

15. The electronic device of claim 12, wherein the processor is specifically configured to:
perform overlaying by taking the at least one virtual three-dimensional prop model as foreground information and the virtual three-dimensional table game scene as background information to obtain the virtual target game scene.

16. The electronic device of claim 12, wherein the processor is specifically configured to:
determine display information of each virtual three-dimensional prop model in the at least one virtual three-dimensional prop model; and
overlay the at least one virtual three-dimensional prop model to the virtual three-dimensional table game scene based on the display information of the at least one virtual three-dimensional prop model to form the virtual target game scene.

17. The electronic device of claim 12, wherein the processor is specifically configured to:
perform the planar projection processing on the virtual target game scene based on a plurality of projection views to obtain a plurality of pieces of two-dimensional image data comprising the at least one kind of table game prop.

18. A computer-readable storage medium having stored therein a computer program which is executed by a processor to implement an image data generation method, the method comprising:
acquiring a plurality of virtual three-dimensional prop models respectively corresponding to a plurality of kinds of table game props, the table game prop being a game tool used in a table game scene;
in a virtual three-dimensional table game scene, randomly determining at least one virtual three-dimensional prop model comprising at least one kind of table game prop from the plurality of virtual three-dimensional prop models;
overlaying the at least one virtual three-dimensional prop model to the virtual three-dimensional table game scene to form a virtual target game scene; and
performing planar projection processing on the virtual target game scene to obtain two-dimensional image data comprising the at least one kind of table game prop.
